(19) United States
(12) Patent Application Publication
(10) Pub. No.: US 2021/0393042 A1
(43) Pub. Date: Dec. 23, 2021

(54) ELECTRIC BED FOR BEING ASSEMBLED AND DISMANTLED WITHOUT USING TOOL

(71) Applicant: STAR SEEDS CO., LTD., Changhua County (TW)

(72) Inventors: Chuan-Hang SHIH, Changhua County (TW); Yu-Chi YANG, Changhua County (TW)

(21) Appl. No.: 17/350,261

(22) Filed: Jun. 17, 2021

(30) Foreign Application Priority Data
Jun. 17, 2020 (TW) 109207635

(51) Int. Cl. A47C 20/04; F16B 12/54; F16B 12/24

(52) U.S. Cl. CPC A47C 20/041; A47C 19/024; F16B 12/24; F16B 12/54

(57) ABSTRACT

An electric bed capable of being assembled and dismantled without the need of using a tool is disclosed. The electric bed includes left and right modules, front and rear transverse beams having two ends bare-handed detachably mounted with the left and right modules respectively, and back, buttock, thigh and lower leg supporting units bare-handed detachably mounted with the left and right modules, respectively. A front actuator has two ends bare-handed detachably and pivotally connected with the front transverse beam and the back supporting unit, respectively. A rear actuator has two ends bare-handed detachably and pivotally connected with the rear transverse beam and the thigh supporting unit, respectively. As such, the electric bed can be easily and conveniently assembled and dismantled in accordance with the user's requirement and can be packed with minimized volume of packing material to reduce the transportation cost.

### BACKGROUND OF THE INVENTION

### 1. Field of the Invention

The present invention relates generally to an electric bed and more particularly, to an electric bed capable of being assembled and dismantled without the need of using a tool.

### 2. Description of the Related Art

Conventional electric bed is generally composed of a fixation frame, a moveable frame, and an actuator, such as electric drive, connected between the fixation frame and the moveable frame. As a result, the conventional electric bed has usually a bulky volume, resulting in high transportation cost. Therefore, the issues of minimizing packing volume to reduce transportation cost, assembling the electric bed by user's bare hands without the need of using a tool, and providing sufficient structural stableness after assembly need to be solved by the manufacturers in this field.

### SUMMARY OF THE INVENTION

The present invention has been accomplished in view of the above-noted circumstances. It is an objective of the present invention to provide an electric bed, which can be assembled and dismantled by a user's bare hand without using a tool, can minimize the volume of the packing material to reduce transportation cost, and has a sufficient structural stableness after assembly.

To attain the above objective, the present invention provides an electric bed adapted for being assembled and dismantled without using a tool. The electric bed comprises left and right modules, front and rear transverse beams, back, buttock, thigh and lower leg supporting units, and front and rear actuators. The left module comprises a left front beam, a left rear beam connected with the left front beam, a left buttock supporting frame mounted on the left front beam, a left back supporting frame pivotally connected with the left front beam, a left thigh supporting frame pivotally connected with the left rear beam, a left lower leg supporting frame pivotally connected with the left thigh supporting frame, and a left link having two ends pivotally connected with the left rear beam and the left lower leg supporting frame, respectively. The right module comprises a right front beam, a right rear beam connected with the right front beam, a right buttock supporting frame mounted on the right front beam, a right back supporting frame pivotally connected with the right front beam, a right thigh supporting frame pivotally connected with the right rear beam, a right lower leg supporting frame pivotally connected with the right thigh supporting frame, and a right link having two ends pivotally connected with the right rear beam and the right lower leg supporting frame, respectively. The front transverse beam has two ends that are bare-handed detachably mounted with the left front beam and the right front beam, respectively. The rear transverse beam has two ends that are bare-handed detachably mounted with the left rear beam and the right rear beam, respectively. The back supporting unit is bare-handed detachably mounted with the left back supporting frame and the right back supporting frame. The buttock supporting unit is bare-handed detachably mounted with the left buttock supporting frame and the right buttock supporting frame. The thigh supporting unit is bare-handed detachably mounted with the left thigh supporting frame and the right thigh supporting frame. The lower leg supporting unit is bare-handed detachably mounted with the left lower leg supporting frame and the right lower leg supporting frame. The front actuator has two ends that are bare-handed detachably and pivotally connected with the front transverse beam and the back supporting unit, respectively. The rear actuator has two ends that are bare-handed detachably and pivotally connected with the rear transverse beam and the thigh supporting unit, respectively.

With the above-mentioned structural features, the electric bed of the present invention can be assembled and dismantled by user's bare hands in accordance with the user's requirement, have a sufficient structural stableness after it is assembled, and have a reduced volume of the packing material to lower the transportation cost.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a top perspective view of an electric bed according to a first embodiment of the present invention;

FIG. 2 is a bottom perspective view of the electric bed of the first embodiment of the present invention;

FIGS. 3-7 are perspective views showing parts of the electric bed of the first embodiment of the present invention, respectively;

FIGS. 8-10 are exploded views showing parts of the electric bed of the first embodiment of the present invention;

FIGS. 11-12 are schematic views showing the electric bed of the first embodiment of the present invention is in a state of use;

FIG. 13 is a schematically exploded view of the electric bed of the first embodiment of the present invention;

FIG. 14 is a schematic view showing the electric bed of the first embodiment of the present invention is in a state to be packed; and

FIG. 15 is a perspective view of an electric bed according to a second embodiment of the present invention.

### DETAILED DESCRIPTION OF THE INVENTION

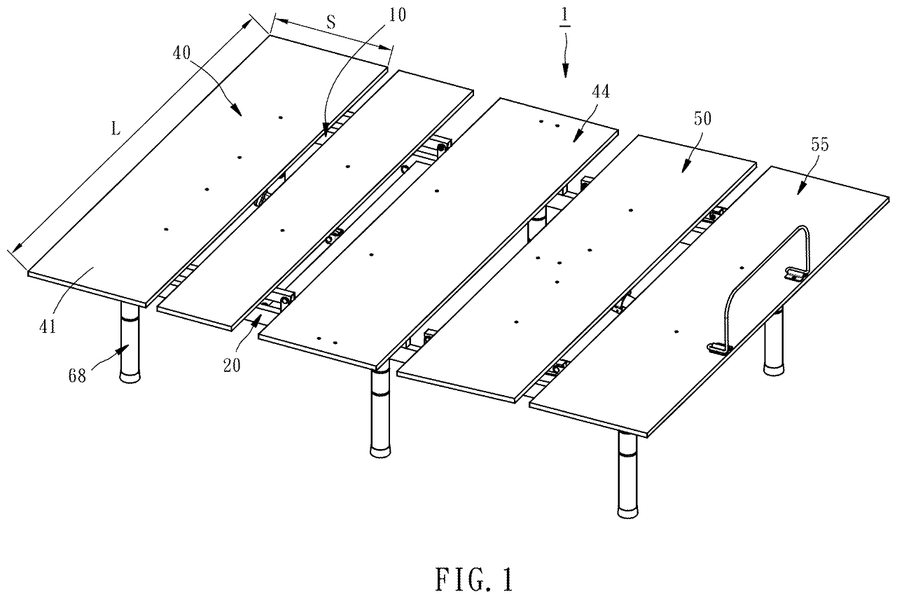

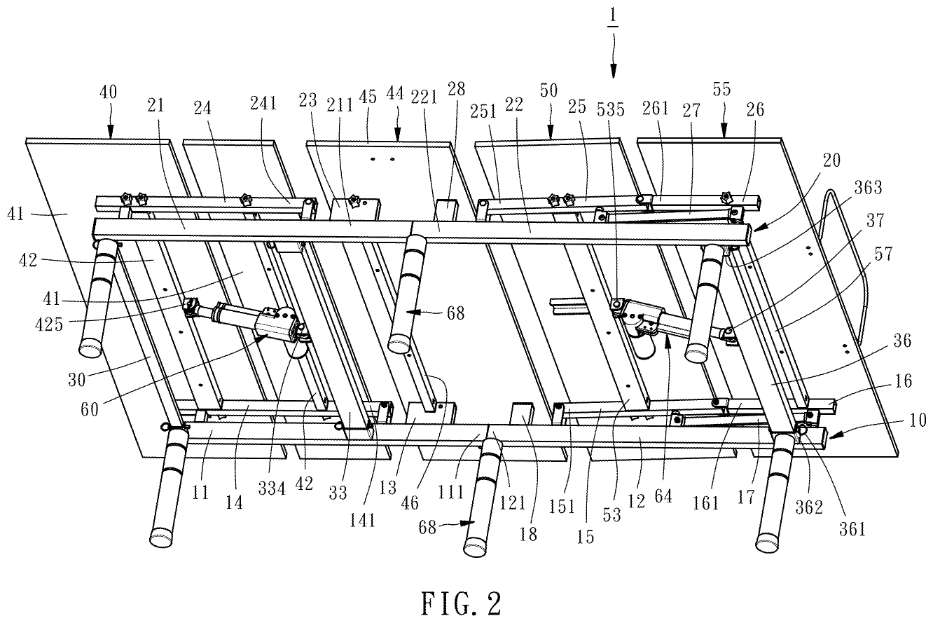

The structure and technical features of the present invention will be detailedly described hereunder by two embodiments and accompany drawings. As shown in FIGS. 1-2, an electric bed 1 capable of being assembled and dismantled by user's bare hands without using a tool is provided in accordance with a first embodiment of the present invention. The electric bed 1 comprises a left module 10, a right module 20, a front transverse rod 30, a front transverse beam 33, a rear transverse beam 36, a back supporting unit 40, a buttock supporting unit 44, a thigh supporting unit 50, a lower leg supporting unit 55, a front actuator 60, a rear actuator 64, and six leg posts 68. It is to be especially mentioned that the directions or the like used in this description are based on the reference directions of FIG. 1. For example, the “front side” or “bed head” of the electric bed 1 is directed to the left side of FIG. 1, and the “rear side” or “bed tail” of the electric bed 1 is directed to the right side of FIG. 1. Similarly, the “top side” and “bottom side” of the electric bed 1 are directed to the upper and lower sides of FIG. 1. These directions or the like are used to illustrate and understand the embodiments of the present invention, not to limit the claim scope of the present invention.

The left module 10 comprises a left front beam 11, a left rear beam 12 having a front end 121 connected with a rear end 111 of the left front beam 11, a left buttock supporting frame 13 mounted to a rear section of the left front beam 11, a left back supporting frame 14 having a rear end 141 pivotally connected with the left front beam 11, a left thigh supporting frame 15 having a front end 151 pivotally connected with the left rear beam 12, a left lower leg supporting frame 16 having a front end 161 pivotally connected with the left thigh supporting frame 15, a left link 17 having two ends pivotally connected with the left rear beam 12 and the left lower leg supporting frame 16 respectively, and a left buttock supporting post 18 mounted with a front section of the left rear beam 12 and abutted with the buttock supporting unit 44. The left rear beam 11 and the left rear beam 12 are aligned with each other in a line. The top surfaces of the left buttock supporting frame 13, the left back supporting frame 14, the left thigh supporting frame 15 and the left lower leg supporting frame 16 are substantially flush with each other.

The right module 20 comprises a right front beam 21, a right rear beam 22 having a front end 221 connected with a rear end 211 of the right front beam 21, a right buttock supporting frame 23 mounted to a rear section of the right front beam 21, a right back supporting frame 24 having a rear end 241 pivotally connected with the right front beam 21, a right thigh supporting frame 25 having a front end 251 pivotally connected with the right rear beam 22, a right lower leg supporting frame 26 having a front end 261 pivotally connected with the right thigh supporting frame 25, a right link 27 having two ends pivotally connected with the right rear beam 22 and the right lower leg supporting frame 26 respectively, and a right buttock supporting post 28 mounted with a front section of the right rear beam 22 and abutted with the buttock supporting unit 44. The right rear beam 21 and the right rear beam 22 are aligned with each other in a line. The top surfaces of the right buttock supporting frame 23, the right back supporting frame 24, the right thigh supporting frame 25 and the right lower leg supporting frame 26 are substantially flush with each other.

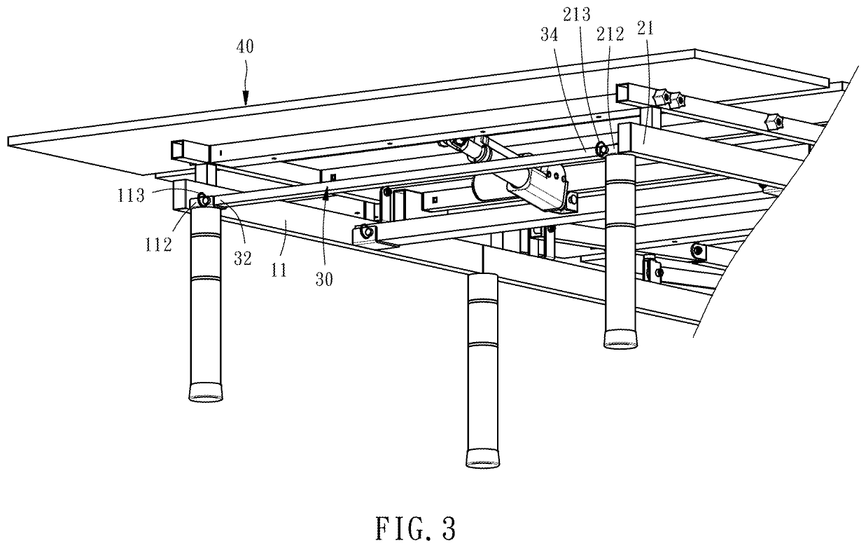

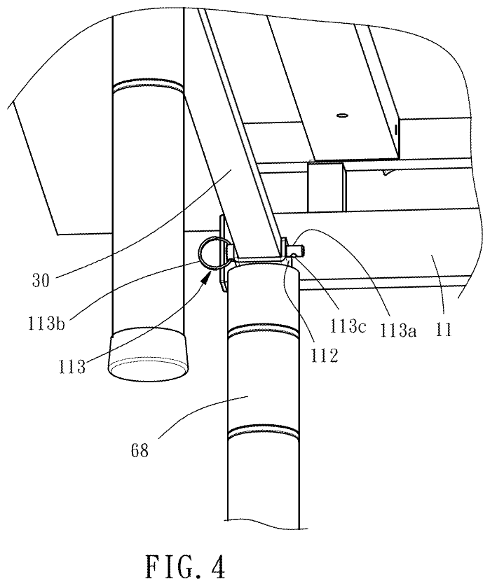

The front transverse rod 30 has left and right ends 32 and 34 that are bare-handed detachably mounted with the front section of the left front beam 11 and the front section of the right front beam 21, respectively. In this embodiment, as shown in FIG. 3, the left front beam 11 has a left support 112 on which the left end 32 of the front transverse rod 30 is disposed. Further, a left pin 113 is penetrated through the front transverse rod 30 and the left support 112, such that the front transverse rod 30 and the left front beam 11 are fixed with each other. Similarly, the right front beam 21 has a right support 212 on which the right end 34 of the front transverse rod 30 is disposed. Further, a right pin 213 is penetrated through the front transverse rod 30 and the right support 212, such that the front transverse rod 30 and the right front beam 21 are fixed with each other. Referring to FIG. 4, the left pin 113 has a body 113a, a pull ring 113b provided at an end of the body 113a, and a steel ball 113c resiliently retractably provided at the other end of the body 113a, such that the left pin 113 will not easily escape. To remove the left pin 113, the user only needs to pull the pull ring 113b to force the steel ball 113c to retract inside the body 113a and then horizontally pull out the left pin 113. In this way, the fixed status between the front transverse rod 30 and the left front beam 11 can be easily released by user's hands. The pull ring 113b facilitates the user's pull and removal of the left pin 113. However, the pull ring 113b and the steel ball 113c may be omitted in other embodiment of the present invention. The structure and function of the right pin 213 are identical to that of the left pin 113; therefore, no detailed description of the right pin 213 is to be repeatedly given here.

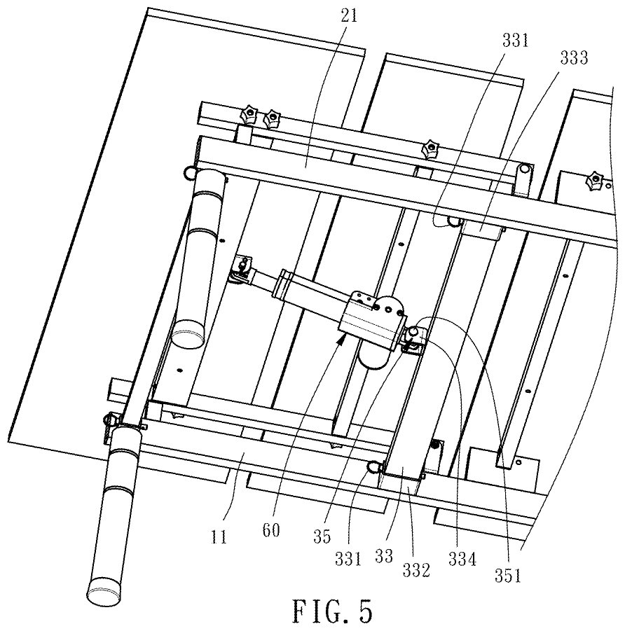

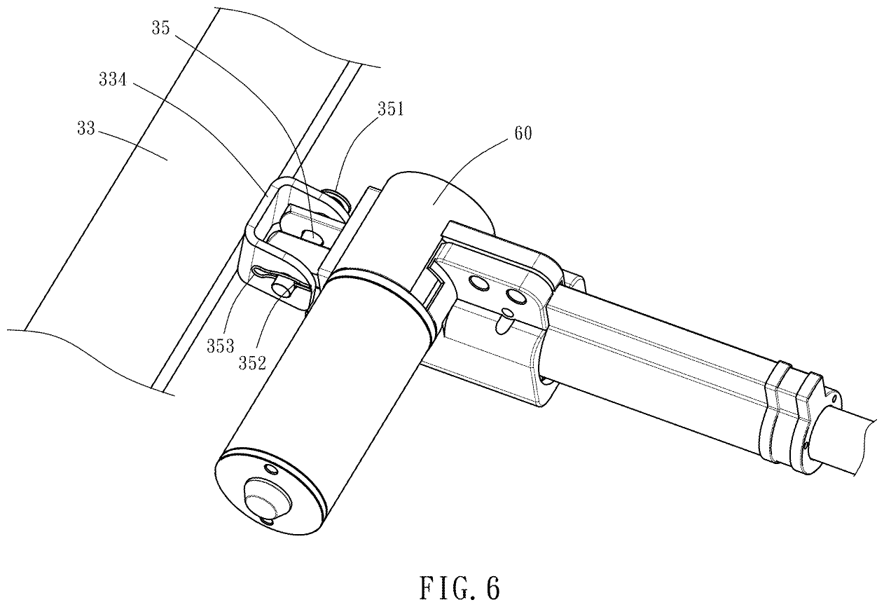

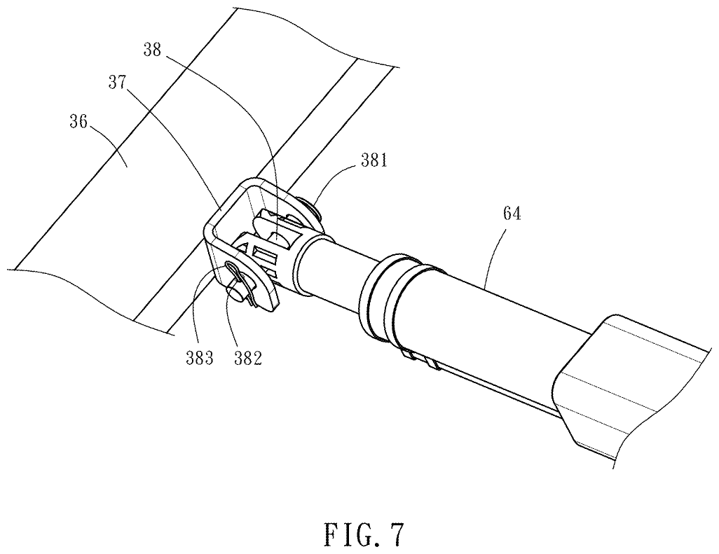

Referring to FIG. 5, the front transverse beam 33 has two ends that are bare-handed detachably mounted with the middle sections of the left and right front beams 11 and 21, respectively. In this embodiment, the left end of the front transverse beam 33 is connected with the left front beam 11 by means of a front pin 331 and a left abutment portion 332 of the left front beam 11, and the right end of the front transverse beam 33 is connected with the right front beam 21 by means of another front pin 331 and a right abutment portion 333 of the right front beam 21. The structure and function of the two front pins 331 are identical to that of the left and right pins 113 and 213; therefore, no detailed description of the front pin 331 is to be repeatedly given here. As shown in FIGS. 5 and 6, the front transverse beam 33 is provided with a front pivot portion 334. A pivot shaft 35 is penetrated through the front pivot portion 334 and one end of the front actuator 60. The pivot shaft 35 is provided at an end thereof with a disc portion 351 and at the other end thereof with a through hole 352 through which a clip 353 is inserted, such that the front actuator 60 is coupled with the front transverse beam 33. By means of pulling out the clip 353 and then horizontally pulling out the pivot shaft 35, the front actuator 60 and the front transverse beam 33 can be departed by user's bare hands from each other. Referring to FIG. 2, the rear transverse beam 36 has two ends that are bare-handed detachably mounted with the rear sections of the left and right rear beams 12 and 22, respectively. Similar to the front transverse beam 33, the rear transverse beam 36 is connected with the left and right rear beams 12 and 22 by means of two rear pins 361 and left and right abutment portions 362 and 363. As shown in FIG. 7, the rear transverse beam 36 is provided with a rear pivot portion 37. A pivot shaft 38 is penetrated through the rear pivot portion 37 and one end of the rear actuator 64. The pivot shaft 38 is provided at an end thereof with a disc portion 381 and at the other end thereof with a through hole 382 through which a clip 383 is inserted, such that the rear actuator 64 is coupled with the rear transverse beam 36. By means of pulling out the clip 383 and then horizontally pulling out the pivot shaft 38, the rear actuator 64 and the rear transverse beam 36 can be departed by user's bare hands from each other.

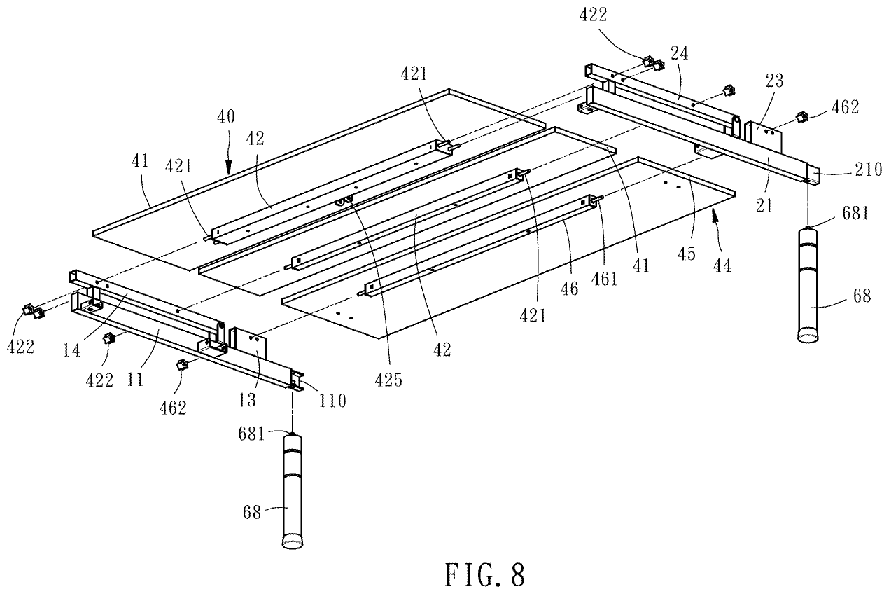

The back supporting unit 40 is bare-handed detachably mounted with the left back supporting frame 14 and the right back supporting frame 24. As shown in FIGS. 2 and 8, the back supporting unit 40 comprises two back supporting portions 41, and two back supporting rods 42 disposed at bottom sides of the back supporting portions 41 respectively in a way that each back supporting rod 42 is bare-handed detachably mounted with the left back supporting frame 14 and the right back supporting frame 24. Each back supporting rod 42 has a left end with at least one threaded shank 421 that is penetrated through the left back supporting frame 14 and threaded with a hand-turnable nut 422, and a right end with at least one threaded shank 421 that is penetrated through the right back supporting frame 24 and threaded with a hand-turnable nut 422, such that each back supporting rod 42 is detachably fixed with the left and right back supporting frames 14 and 24. In this embodiment, each of the left and right ends of the front back supporting rod 42 is provided with two threaded shanks 421, each of which is threaded into a hand-turnable nut 422. Each of the left and right ends of the rear back supporting rod 42 is provided with one threaded shank 421, which is threaded into a hand-turnable nut 422. In this way, by means of tightening or loosening the hand-turnable nuts 422 by user's bare hands, the back supporting unit 40 can be assembled or dismantled. In another aspect, the front back supporting rod 42 is provided at a rear side thereof with a pivot mount 425.

The buttock supporting unit 44 is bare-handed detachably mounted with the left buttock supporting frame 13 and the right buttock supporting frame 23. The buttock supporting unit 44 comprises a buttock supporting portion 45 and a buttock supporting rod 46 disposed at a bottom side of the buttock supporting portion 45 in a way that the buttock supporting rod 46 is bare-handed detachably mounted with the left buttock supporting frame 13 and the right buttock supporting frame 23. As shown in FIG. 2, the left and right buttock supporting posts 18 and 28 are abutted against the buttock supporting portion 45 to provide a stable supporting force. In this embodiment, the buttock supporting rod 46 comprises a left end with a threaded shank 461 that is penetrated through the left buttock supporting frame 13 and threaded with a hand-turnable nut 462, and a right end with a threaded shank 461 that is penetrated through the right buttock supporting frame 23 and threaded with a hand-turnable nut 462, such that the buttock supporting rod 46 is detachably fixed with the left and right buttock supporting frames 13 and 23. By means of tightening or loosening the hand-turnable nuts 462 by user's bare hands, the buttock supporting unit 44 can be assembled or dismantled.

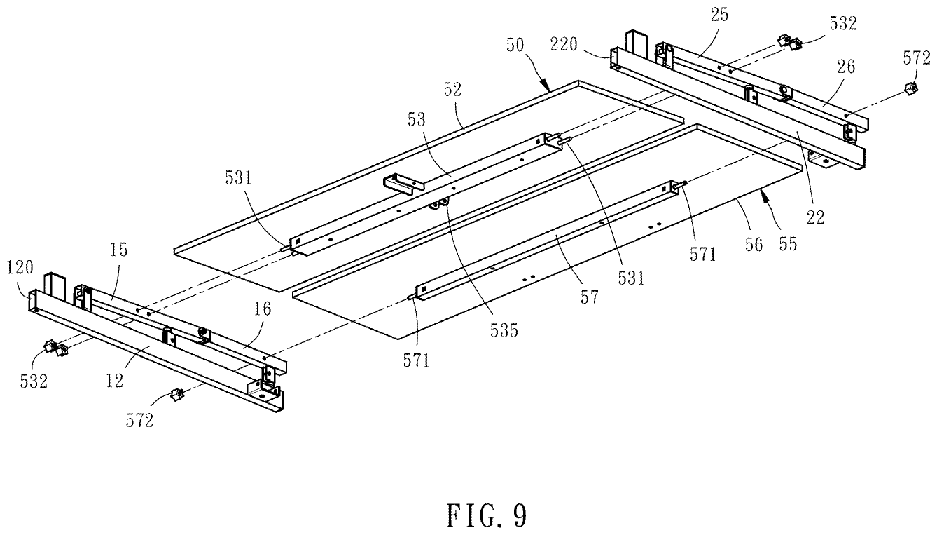

As shown in FIG. 9, the thigh supporting unit 50 is bare-handed detachably mounted with the left thigh supporting frame 15 and the right thigh supporting frame 25. The thigh supporting unit 50 comprises a thigh supporting portion 52 and a thigh supporting rod 53 disposed at the bottom side of the thigh supporting portion 53 in a way that the thigh supporting rod 53 is bare-handed detachably mounted with the left thigh supporting frame 15 and the right thigh supporting frame 25. In this embodiment, each of the left and right ends of the thigh supporting rod 53 is provided with two threaded shanks 531, each of which is penetrated through the left thigh supporting frame 15 or the right thigh supporting frame 25 and then threaded into a hand-turnable nut 532, so that the thigh supporting rod 53 is fixed between the left and right thigh supporting frames 15 and 25. In this way, by means of tightening or loosening the hand-turnable nuts 552 by user's bare hands, the thigh supporting unit 50 can be assembled or dismantled. In another aspect, the thigh supporting rod 53 is provided at a rear side thereof with a pivot mount 535.

The lower leg supporting unit 55 is bare-handed detachably mounted with the left lower leg supporting frame 16 and the right lower leg supporting frame 26. The lower leg supporting unit 55 comprises a lower leg supporting portion 56 and a lower leg supporting rod 57 disposed at the bottom side of the lower leg supporting portion 56 in a way that the lower leg supporting rod 57 is bare-handed detachably mounted with the left lower leg supporting frame 16 and the right lower leg supporting frame 26. In this embodiment, each of the left and right ends of the lower leg supporting rod 57 is provided with one threaded shank 571 penetrated through the left lower leg supporting frame 16 or the right lower leg supporting frame 26 and then threaded into a hand-turnable nut 572, so that the lower leg supporting rod 57 is fixed between the left and right lower leg supporting frames 16 and 26. In this way, by means of tightening or loosening the hand-turnable nuts 572 by user's bare hands, the lower leg supporting unit 55 can be assembled or dismantled.

The above-described back supporting portion 41, the buttock supporting portion 45, the thigh supporting portion 52, and the lower leg supporting portion 56 may be, but not limited to, wood plate, metal net or other equivalent member having a supporting function. The aforesaid hand-turnable nuts 422, 462, 532 and 572 may be, but not limited to, plum nuts, wing nuts, etc.

The front actuator 60 has two ends that are bare-handed detachably and pivotally connected with the front pivot portion 334 of the front transverse beam 33 and the pivot mount 425 of the back supporting rod 42 of the back supporting unit 40 by pins as like as ones disclosed above, respectively. Similarly, the rear actuator 64 has two ends that are bare-handed detachably and pivotally connected with the rear pivot portion 37 of the rear transverse beam 36 and the pivot mount 535 of the thigh supporting rod 53 of the thigh supporting unit 50 by pins as like as ones disclosed above, respectively.

The front and rear actuators 60 and 64 may be, but not limited to, electric lead screw, pneumatic cylinder, or hydraulic cylinder.

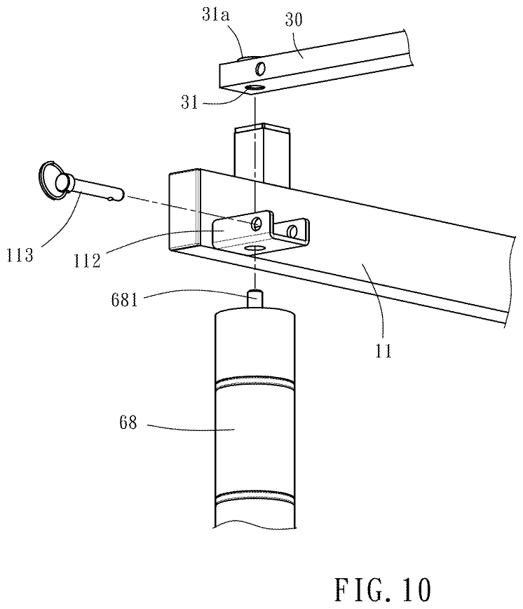

Each leg post 68 includes a top end from which a top threaded shank 681 extends, as shown in FIG. 10. By means of the stop threaded shanks 681, the six leg posts 68 are bare-handed detachably mounted with the left and right modules 10 and 20. Specifically, the six leg posts 68 are mounted to the left front beam 11, the left rear beam 12, the right front beam 21 and the right rear beam 22 respectively, to support the electric bed at a predetermined height to fulfill ergonomics. When these leg posts 68 are not installed, the electric bed 1 can be placed on a general bedstead for use. FIG. 10 is an exploded view showing one of the leg posts 68, a part of the left front beam 11 and a part of the front transverse rod 30. As shown in FIG. 10, the top threaded shank 681 of the leg post 68 is penetrated through the left support 112 and threaded into a threaded hole 31 of the front transverse rod 30, such that the leg post 68 can be detachably connected by user's bare hands with the left front beam 11 of the left module 10 and the front transverse rod 30. That is, by turning the leg post 68 with user's hands, the leg post 68 can be installed or dismantled. In another aspect, the threads of the threaded hole 31 can be directly provided inside the front transverse rod 30. Alternatively, a nut 31a for being engaged with the top threaded shank 681 may be embedded inside the front transverse rod 30 to provide the threaded hole 31. The structures of the leg posts 68 at four corners of the electric bed 1 are same as that of the leg post 68 shown in FIG. 10;

therefore, no details thereof need to be repeatedly described here.

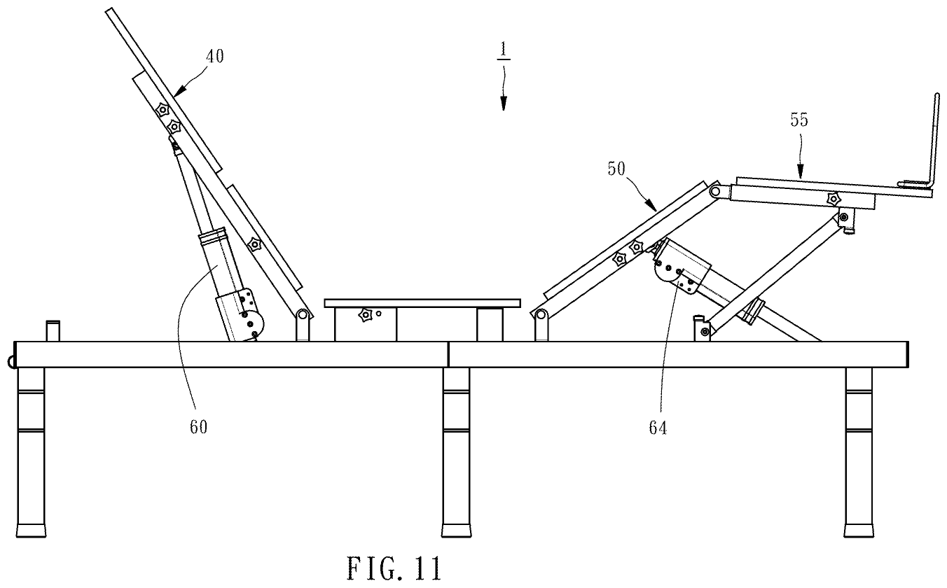

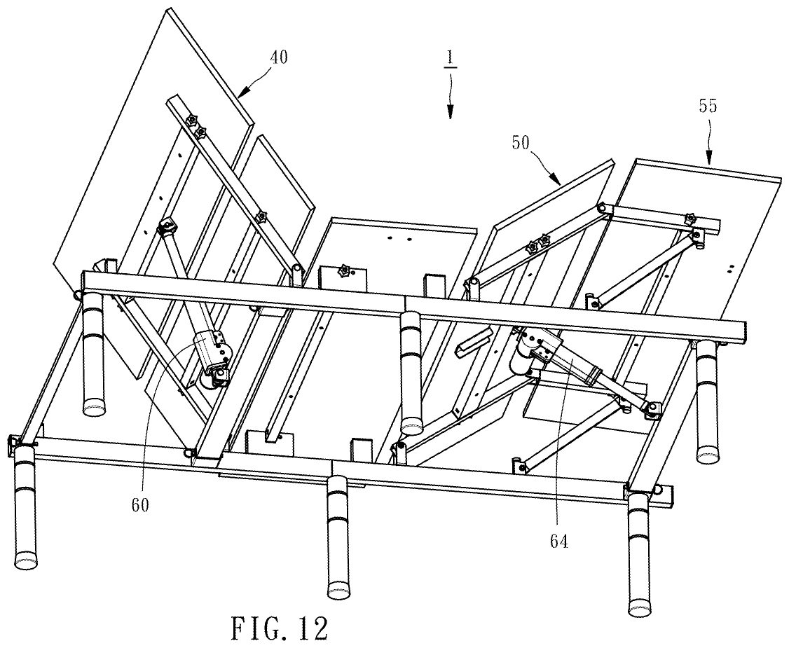

As shown in FIGS. 11-12, when the front actuator 60 extends to enlarge its total length, the back supporting unit 40 is driven by the front actuator 60 to upwardly swing to adjust its inclined angle. When the rear actuator 64 extends to enlarge its total length, the thigh supporting unit 50 and the lower leg supporting unit 55 are upwardly swung or moved, thereby achieving the function of adjusting angles of various parts of the electric bed 1.

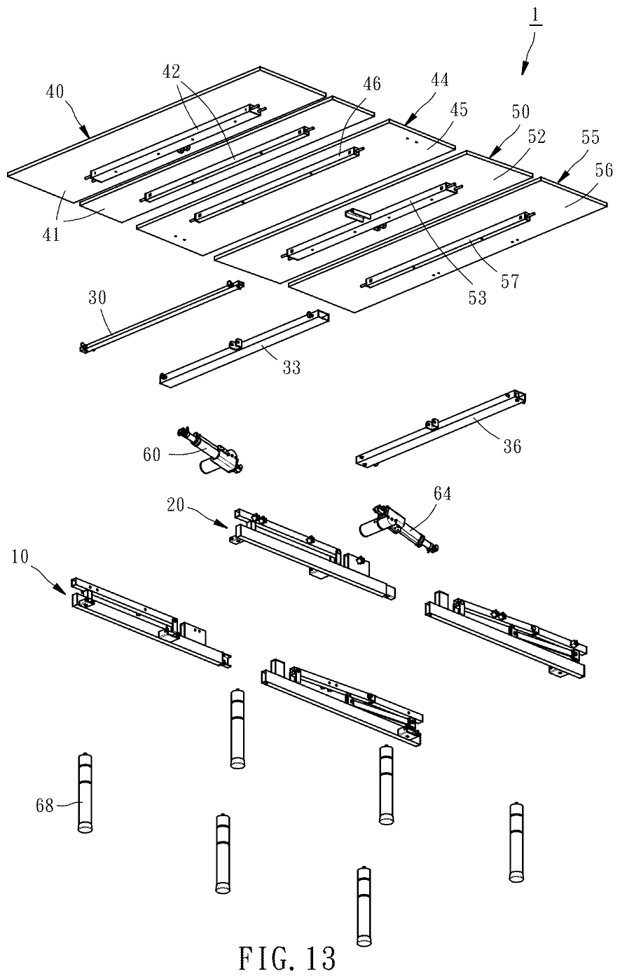

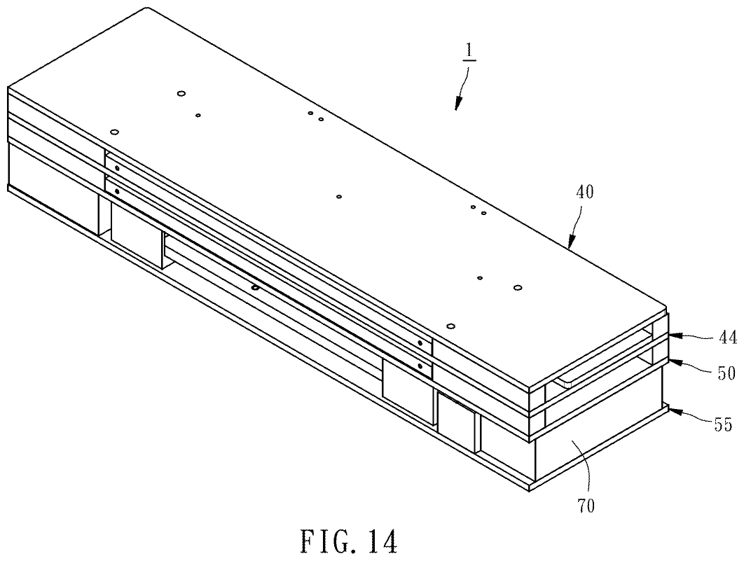

Further, as shown in FIGS. 2, 8 and 9, the left front beam 11 includes a rear post 110, and the left rear beam 12 includes a front hole 120 into which the rear post 110 is inserted. Similarly, the right front beam 21 includes a rear post 210, and the right rear beam 22 includes a front hole 220 into which the rear post 210 is inserted. At the middle of the electric bed 1, two above-mentioned leg posts 68 are provided. The top threaded shank 681 of one of the two leg posts 68 is penetrated through the left rear beam 12 and then threaded with the rear post 110 of the left front beam 11 in a way that the top end of the one of the leg posts 68 is abutted with the bottom side of the left front beam 11. The top threaded shank 681 of the other leg post 68 is penetrated through the right rear beam 22 and then threaded with the rear post 210 of the right front beam 21 in a way that the top end of the other leg post 68 is abutted with the bottom side of the right front beam 21. As such, the left front beam 11 and the left rear beam 12 as well as the right front beam 21 and the right rear beam 22 can be assembled with and dismantled from each other by user's bare hands. In another feasible embodiment, positions of the rear post and the front hole are exchanged. Because the left front beam 11 and the left rear beam 12 is separatable from each other, the length of the left module 10 can be reduced to a half of the original length of the left module 10 in use. Similarly, the length of the right module 20 can be reduced to a half of the original length of the right module 20 in use, too. As a result, the length of each unit will not greater than the length L of the long side of the rectangle-shaped back supporting unit 40, as shown in FIG. 1. Since the back, buttock, thigh and lower leg supporting units 40, 44, 50 and 55 are shaped like rectangles having same length of the long sides, when all of the units of the electric bed 1 are stacked and packed, the length L of the long side will be the longest length of the units or the packing, and the length S of the short side of the back supporting portion 41 of the back supporting unit 40 will be the greatest width of the all units or the packing. Therefore, as shown in FIGS. 13 and 14, when all of the units are dismantled and stacked by user's bare hands and may be further packed by a plurality of packing materials, the total volume can be minimized, thereby not only facilitating transportation to save transportation cost but also allowing user to easily and conveniently assemble or dismantle the electric bed 1 in accordance with the user's need. The most important thing lies in that the task of assembling and dismantling the electric bed 1 of the present invention needs not to use any tool thanks to the simplified structural design of the present invention. Further, the assembled electric bed 1 has good structural strength without the unstable problem that the conventional do-it-yourself (DIY) furniture may have.

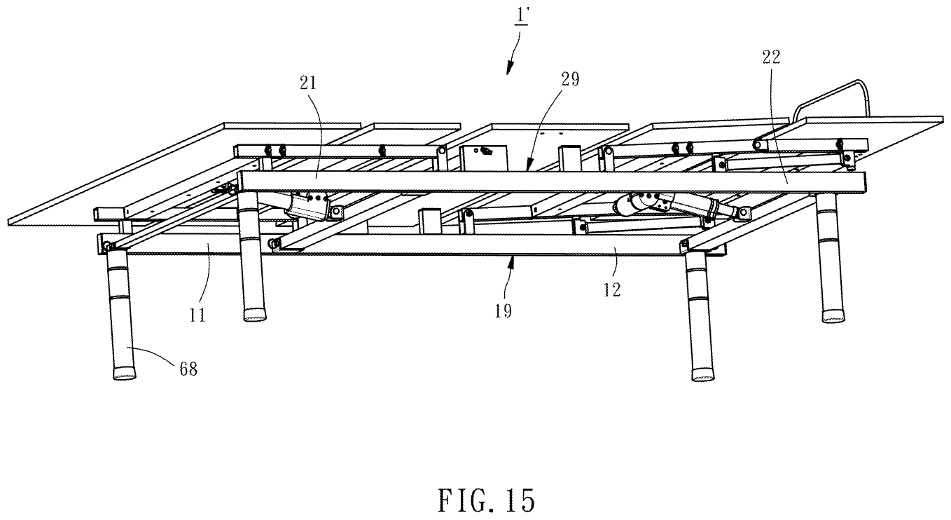

Based on the technical features of the present invention, various modifications to the electric bed 1 may be made. For example, FIG. 15 shows an electric bed 1 requiring no tool in assembly and dismantling in accordance with a second embodiment of the present invention. In this embodiment, the left front beam 11 and the left rear beam 12 are monolithically formed as a left beam 19, the right front beam 21 and the right rear beam 22 are monolithically formed as a right beam 29, and only four leg posts 68 are provided. Further, the numbers of the threaded shanks and the hand-turnable nuts may be increased or reduced in accordance with actual requirement, i.e., not limited to the ones disclosed in the above-mentioned embodiment. Such variations are not to be regarded as a departure from the spirit and scope of the invention, and all such modifications as would be obvious to one skilled in the art are intended to be included within the scope of the following claims.

What is claimed is:

1. An electric bed for being assembled and dismantled without using a tool, the electric bed comprising:
a left module, which comprises a left front beam, a left rear beam connected with the left front beam, a left buttock supporting frame mounted on the left front beam, a left back supporting frame pivotally connected with the left front beam, a left thigh supporting frame pivotally connected with the left rear beam, a left lower leg supporting frame pivotally connected with the left thigh supporting frame, and a left link having two ends pivotally connected with the left rear beam and the left lower leg supporting frame, respectively;
a right module, which comprises a right front beam, a right rear beam connected with the right front beam, a right buttock supporting frame mounted on the right front beam, a right back supporting frame pivotally connected with the right front beam, a right thigh supporting frame pivotally connected with the right rear beam, a right lower leg supporting frame pivotally connected with the right thigh supporting frame, and a right link having two ends pivotally connected with the right rear beam and the right lower leg supporting frame, respectively;
a front transverse beam having two ends that are bare-handed detachably mounted with the left front beam and the right front beam, respectively;
a rear transverse beam having two ends that are bare-handed detachably mounted with the left rear beam and the right rear beam, respectively;
a back supporting unit bare-handed detachably mounted with the left back supporting frame and the right back supporting frame;
a buttock supporting unit bare-handed detachably mounted with the left buttock supporting frame and the right buttock supporting frame;
a thigh supporting unit bare-handed detachably mounted with the left thigh supporting frame and the right thigh supporting frame;
a lower leg supporting unit bare-handed detachably mounted with the left lower leg supporting frame and the right lower leg supporting frame;
a front actuator having two ends that are bare-handed detachably and pivotally connected with the front transverse beam and the back supporting unit, respectively; and
a rear actuator having two ends that are bare-handed detachably and pivotally connected with the rear transverse beam and the thigh supporting unit, respectively.

2. The electric bed as claimed in claim 1, further comprising a front transverse rod having left and right ends that are bare-handed detachably mounted with the left front beam and the right front beam, respectively.

3. The electric bed as claimed in claim 2, wherein the left front beam comprises a left support on which the left end of the front transverse rod is disposed; a left pin is penetrated through the front transverse rod and the left support to fix the front transverse rod with the left front beam.

4. The electric bed as claimed in claim 3, wherein the left pin is provided at an end thereof with a pull ring.

5. The electric bed as claimed in claim 3, further comprising a leg post; the leg post includes a top end from which a top threaded shank extends; the top threaded shank is penetrated through the left support and threaded into a threaded hole of the front transverse rod, such that the leg post is bare-handed detachably connected with the left module and the front transverse rod.

6. The electric bed as claimed in claim 1, wherein the back supporting unit comprises a back supporting portion and a back supporting rod disposed with the back supporting portion in a way that the back supporting rod is bare-handed detachably mounted with the left back supporting frame and the right back supporting frame.

7. The electric bed as claimed in claim 6, wherein the back supporting rod comprises a left end having a threaded shank that is penetrated through the left back supporting frame and threaded with a hand-turnable nut, and a right end having a threaded shank that is penetrated through the right back supporting frame and threaded with a hand-turnable nut, such that the back supporting rod is detachably fixed with the left and right back supporting frames.

8. The electric bed as claimed in claim 1, wherein the front transverse beam is provided with a front pivot portion; a pivot shaft is penetrated through the front pivot portion and one of the two ends of the front actuator; the pivot shaft is provided at an end thereof with a disc portion and at the other end thereof with a through hole through which a clip is inserted, such that the front actuator is coupled with the front transverse beam.

9. The electric bed as claimed in claim 1, wherein the buttock supporting unit comprises a buttock supporting portion and a buttock supporting rod disposed with the buttock supporting portion in a way that the buttock supporting rod is bare-handed detachably mounted with the left buttock supporting frame and the right buttock supporting frame.

10. The electric bed as claimed in claim 9, wherein the buttock supporting rod comprises a left end having a threaded shank that is penetrated through the left buttock supporting frame and threaded with a hand-turnable nut, and a right end having a threaded shank that is penetrated through the right buttock supporting frame and threaded with a hand-turnable nut, such that the buttock supporting rod is detachably fixed with the left and right buttock supporting frames.

11. The electric bed as claimed in claim 1, wherein the thigh supporting unit comprises a thigh supporting portion and a thigh supporting rod disposed with the thigh supporting portion in a way that the thigh supporting rod is bare-handed detachably mounted with the left thigh supporting frame and the right thigh supporting frame.

12. The electric bed as claimed in claim 1, wherein the rear transverse beam is provided with a rear pivot portion; a pivot shaft is penetrated through the rear pivot portion and one of the two ends of the rear actuator; the pivot shaft is provided at an end thereof with a disc portion and at the other end thereof with a through hole through which a clip is inserted, such that the rear actuator is coupled with the rear transverse beam.

13. The electric bed as claimed in claim 1, wherein the left module further comprises a left buttock supporting post mounted with the left rear beam and abutted with the buttock supporting unit; the right module further comprises a right buttock supporting post mounted with the right rear beam and abutted with the buttock supporting unit.

14. The electric bed as claimed in claim 1, wherein the lower leg supporting unit comprises a lower leg supporting portion and a lower leg supporting rod disposed with the lower leg supporting portion in a way that the lower leg supporting rod is bare-handed detachably mounted with the left lower leg supporting frame and the right lower leg supporting frame.

15. The electric bed as claimed in claim 1, further comprising a leg post; the leg post includes a top end from which a top threaded shank extends; the top threaded shank is penetrated through the left rear beam and threaded with the left front beam in a way that the top end of the leg post is abutted with the left front beam.

16. The electric bed as claimed in claim 1, wherein the left front beam comprises a rear post; the left rear beam includes a front hole into which the rear post is inserted.

17. The dismantlable electric bed as claimed in claim 1, wherein the left front beam is monolithically formed with the left rear beam.
